(19) United States
(12) Patent Application Publication
(10) Pub. No.: US 2016/0150257 A1
(43) Pub. Date: May 26, 2016

(54) SYSTEMS AND METHODS FOR CREATING AND BROADCASTING A CHANNEL TO ONE OR MORE DEVICE

(71) Applicant: Squaredon Co LTD, Larnaca (CY)

(72) Inventors: Igor Sokolov, Saint-Petersburg (RU); Leonid Belyaev, Moscow (RU); Artem Kirakosyan, St. Petersburg (RU); Ilya Baronshin, Moscow (RU)

(21) Appl. No.: 14/549,530

(22) Filed: Nov. 20, 2014

(51) Int. Cl. H04N 21/2543; H04N 7/16; H04N 21/2668; H04N 21/418; H04N 21/235; H04N 21/8405; H04N 21/81; H04N 21/4623

(52) U.S. Cl. CPC H04N 21/25435; H04N 21/812; H04N 7/163; H04N 21/4623; H04N 21/4181; H04N 21/2353; H04N 21/8133; H04N 21/8405; H04N 21/2668; H04N 21/2543

(57) ABSTRACT

Disclosed is a system to present channels at a channel store accessible by devices in accordance with various embodiments. In an aspect, the system can comprise a transcoding component that converts the information corresponding to the set of channels from a system format and a system specification to converted information comprising a first format and a first specification of a first device and a second format and a second specification of a second device; a transmission component that transmits at least the converted information via a broadcast signal or a video data stream to an application comprising a channel store, wherein the channel store is accessible by the first device and the second device; a presentation component that presents a set of channel cards and channel metadata via a user interface of the channel store, wherein the set of channel cards represent corresponding ones of the set of channels.

### TECHNICAL FIELD

This disclosure relates generally to customized channels comprising live broadcast and previously broadcast video content presented at a channel store for purchase on a variety of devices.

### BACKGROUND

Traditionally, the work of broadcasting television (TV) channels to televisions arises from arrangements between a broadcast operator (e.g., cable, satellite, etc.) and a channel owner. The broadcast operator distributes the channel via transmission of a broadcast signal. However, where the channel owner seeks to distribute the channel to various networks and devices, aside from television (e.g., computer, tablet, mobile device, etc.), the channel owner must incur costs to transcode the channel content to various network formats, device formats and specifications. Furthermore, the channel owner also incurs costs associated with developing an application to distribute the channel on various platforms (e.g., web, mobile, smart television, etc.) and application management fees. Other associated expenses incurred are in reference to promotions, advertising, and marketing related to the application. For many small channel owners or niche channel owners, distributing the channel to many user devices is cost prohibitive. Given the high cost of distributing a channel across an established network to large audiences, the channel owner must attract advertisement revenues and bear distribution costs. Currently, there is no solution that to allows channel owners to distribute a channel to many devices and at an affordable rate.

The above-described background relating to live broadcasting of video content corresponding to a channel, is merely intended to provide a contextual overview of some current issues, and is not intended to be exhaustive. Other contextual information may become further apparent upon review of the following detailed description.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with broadcasting a channel to one or more devices. In accordance with a non-limiting embodiment, in an aspect, a system is provided comprising a memory having stored thereon executable components and that stores information corresponding to a set of channels, wherein each of the set of channels comprises video content associated with at least one video; and a processor, coupled to the memory, configured to execute or facilitate execution of the executable components, the executable components comprising a transcoding component, a transmission component, a presentation component, and a subscription component.

In an aspect, a transcoding component converts the information corresponding to the set of channels from a system format and a system specification to converted information comprising a first format and a first specification of a first device and a second format and a second specification of a second device; a transmission component transmits at least the converted information via a broadcast signal or a video data stream to an application comprising a channel store, wherein the channel store is accessible by the first device and the second device; a presentation component presents a set of channel cards and channel metadata via a user interface of the channel store, wherein the set of channel cards represent corresponding ones of the set of channels; and a subscription component that facilitates access to a subset of the set of channels represented by a subset of the set of channel cards selected for consumption via the first device or the second device.

In various other embodiments, the system can further comprise a promotion component that includes an advertisement within the video content and user interface of the channel store, wherein the advertisement promotes a brand or the video content. Also, in an embodiment, the system can further comprise wherein the executable components further comprise a selection component that facilitates selection of the subset of channels represented by the subset of channel cards for the consumption via the first device or the second device. In yet another aspect, an embodiment can comprise a management component that permits or restricts the presentation of the video content at least in part via the first device or via the second device based on a user designated preference or an administrator designated preference.

The disclosure further discloses a method, comprising storing, by a device comprising a processor, information corresponding to one or more channels, wherein each channel of the one or more channels comprises video content associated with at least one video; converting the information to converted information corresponding to the one or more channels from a standard format and a standard specification into multiple formats and multiple specifications corresponding to respective target formats and respective target specifications of respective target devices; broadcasting or transmitting the converted information as a video stream to the target device; instructing the converted information to be presented as a set of channel cards via an interface of a channel store of a target device of the respective target devices, wherein the set of channel cards respectively represents the one or more channels; and selecting a subset of the set of channels represented by a corresponding subset of the set of channel cards for consumption by the target device.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a non-limiting exemplary system for creating and broadcasting a channel including channel storing, transcoding, transmitting, presentation, and subscription.

FIG. 2 illustrates a non-limiting exemplary system for creating and broadcasting a channel including channel storing, transcoding, transmitting, presentation, subscription, and promotion.

FIG. 3 illustrates a non-limiting exemplary system for creating and broadcasting a channel including channel storing, transcoding, transmitting, presentation, subscription, promotion, and selection.

FIG. 4 illustrates a non-limiting exemplary system for creating and broadcasting a channel including channel storing, transcoding, transmitting, presentation, subscription, promotion, selection and billing for services.

FIG. 5 illustrates a non-limiting exemplary system for creating and broadcasting a channel including channel storing, transcoding, transmitting, presentation, subscription, promotion, selection, purchasing and billing for services.

FIG. 6 illustrates a non-limiting exemplary system for creating and broadcasting a channel including channel storing, transcoding, transmitting, presentation, subscription, promotion, selection, purchasing, management and billing for services.

FIG. 7 illustrates a non-limiting exemplary system for creating and broadcasting a channel including channel storing, transcoding, transmitting, presentation, subscription, promotion, selection, purchasing, management, grouping and billing for services.

FIG. 8 illustrates a non-limiting exemplary system for creating and broadcasting a channel including channel storing, transcoding, transmitting, presentation, subscription, promotion, selection, purchasing, management, grouping, protection and billing for services.

FIG. 9 illustrates a schematic process flow diagram of an example method of rendering a channel to one or more devices via channel store.

FIG. 10 illustrates a schematic process flow diagram of an example method of rendering a channel to one or more devices via channel store.

FIG. 11 illustrates a schematic process flow diagram of an example method of rendering a channel to one or more devices via channel store.

FIG. 12 illustrates a schematic process flow diagram of an example method of rendering a channel to one or more devices.

FIG. 13 illustrates a block diagram of an example mobile handset operable to engage in a system architecture that facilitates secure wireless communication according to the embodiments described herein.

FIG. 14 illustrates a block diagram of an example computer operable to engage in a system architecture that facilitates secure wireless communication according to the embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies and other drawbacks of broadcasting video content to one or more devices, various embodiments are described herein to facilitate the broadcasting of a dynamic channel including video streams, audio streams, and metadata, in agreed upon specifications and formats to various devices. In an aspect, the dynamic channel also referred to as a smart channel can be distributed across platforms by making use of a channel store such that consumers can select any smart channel for consumption via devices able to access the smart channel.

In an aspect, smart channels can operate on TV or computer systems, including tablets and mobile phones where video can be rendered through an internal or external screen. Video content can be delivered by any available transport, including but not limited to, digital video broadcasting (DVB), satellite (SAT) TV, IP, over the top (OTT) content, and/or information data feed. A smart TV channel can allow a user to watch live broadcast content or on-demand broadcast content, which was previously broadcast, within the same broadcast channel. The previous broadcast content can be split into pieces of content, enriched by metadata and presented as on-demand video content, where a user can choose to watch any piece of content available on the channel. Combining previously broadcast channel content with currently broadcast channel content with video on-demand (VOD) and advanced navigation patterns can reduce traditional TV broadcast limitations. Displaying previously broadcast content on a particular channel, without scheduling, at the same time as watching live broadcast content on the same channel can transform a traditional channel from one direction of navigation to a dynamic channel having multiple directions of navigation. For instance, content can be chosen inside the channel by using algorithms for episode grouping or by using algorithms to watch all episodes of a particular show one-by-one.

The smart channel can allow for selection and viewing of a program that was on the smart channel previously and make the program available for additional playbacks. The smart channel can be programmed based on a user preference for watching video content. The smart channel can also allow the user to ban, delete, or skip recorded or currently broadcast video content, which the user would like to exclude from the channel. The exclusion of certain broadcast content can be predicated upon, but is not limited to, topics, keywords, and broadcast times. The smart channel can be programmed to render all episodes, one-by-one, that are available on the smart channel and were broadcasted within a specific time frame. The smart channel can have multiple paths for navigating the contents within. For instance, the smart channel can group episodes of a specific franchise and display them and provide an option to filter each episode by a particular character.

The smart channel can allow for manual or automatic fragmentation of video content within the channel by partitioning the video content and applying metadata. The metadata can include, but is not limited to, text, pictures, videos, and user generated metadata. Further, the video content can be identified via an external metadata source and/or timestamps within the smart channel itself. Metadata can be applied to the video content and/or the smart channel itself, where the smart channel metadata can include, but is not limited to, descriptions, video fragments, etc.

In an aspect, the smart channels themselves can be presented at a channel store where consumers can browse through channel catalogues and select those channels most appealing for consumption. The channel store allows for efficient consumption of content wherein the consumer views and pays for only those channels of interest. Traditionally, networks, such as television networks charge a set amount of money for a bundle of channels, some of which the consumer may not wish to consume. The channel store comprising smart channels allows the consumer to select a channel of interest a-la carte, learn about the channel contents, and purchase the channel on any of a variety of devices (e.g., television, set-top box, mobile device, etc.).

The channel store also benefits channel owners (also referred to as broadcasters), wherein the channel store provides a platform for broadcasters to present and sell customized channels to consumers on several devices. In an aspect, the platform provides a means whereby a broadcaster can store a customized channel, convert the stored information to a variety of format and specification requirements belonging to a range of devices, transmit the converted information to the devices, present the information at a channel store, allow consumers to subscribe to the channel and consume the content for a fee. The platform and channel store is a one-stop shop for a broadcaster allowing the channel to reach a wide audience, distributing the channel to multiple devices, reducing the overhead associated with traditional broadcasting, and increasing the revenue generated by providing content choice to the consumer.

In an aspect, the broadcaster can also promote, market, or advertise content at the channel store. The broadcaster can also receive a payment from a consumer via the channel store interface in accordance with established prices or subscription fees for access to content. Furthermore, the broadcaster can define the price and terms of the channel to be offered at the channel store. In another aspect, the broadcaster has control over the customization of the channel, by creating channel cards representing the channel, wherein the channel cards can comprise logos, branding elements, video trailers, and other such channel attributes that can be deployed at the channel store. In another aspect, the channel cards can comprise a channel title, a channel description, popular video content for the channel, a video content trailers, an age rating of the video content or the whole channel, a channel genre, a channel price, purchasing options, video content streaming options, or subscription information relating to a subscription to the channel.

The channel store can comprise of a multitude of smart channels wherein each smart channel can comprise a number of unique features. For instance, the smart channel can allow for a fast-forwarded view of currently broadcast video content, a rewound view of the currently broadcasted video content, an on-demand view of previously broadcasted video content, and/or featured video content associated with the smart channel. Furthermore, time-shifted content of the smart channel can loop like a circular or linear feed within a certain time period, allowing for a selection of any video content in the feed. The feed can automatically update by deleting old video content or add new video content as soon as the video content goes live or live video content becomes available for VOD. If the video content is available live, but not allowed on demand, it can disappear from feed as soon as the live broadcast is finished.

The smart channel can also be promoted, using video content snippets and/or its metadata, within the smart channel service or other channels. The smart channel can allow video content tagging within the channel, including but not limited to, editorials, closed captions, subtitles, speech to text, text to speech, etc. Tagging can also include prioritizing the video content by topics and by keywords from the channel audio track.

Metadata can be used to personalize the smart channel. The smart channel can also be personalized via a user's watching history and preferences. The smart channel can also be customized based on what a user is not watching or what video content the user has skipped. Viewing behavior such as viewing a series of related video content, time a viewing took place, or frequency of viewing can be recorded and analyzed either separately or in combination to create a personalized viewing experience. The user can also explicitly tag video content, as liked or disliked, to further the smart channel's analysis of viewing behavior. The user can dictate how video content should be rendered. For instance, the user can define what video content the smart channel should render next.

Certain video content can only be available via a subscription to the video content within the smart channel. Subscription-based content can be provided by a third-party in addition to the video content available within the smart channel. Analysis of data associated with user viewing behavior can be used to suggest or provide options for viewing video content related to the data associated with the user viewing behavior. User viewing behavior and personalization of the smart channel can be associated with a user identification method, including but not limited to, user logins, passwords, face recognition, biometrics, mobile device pairing, etc.

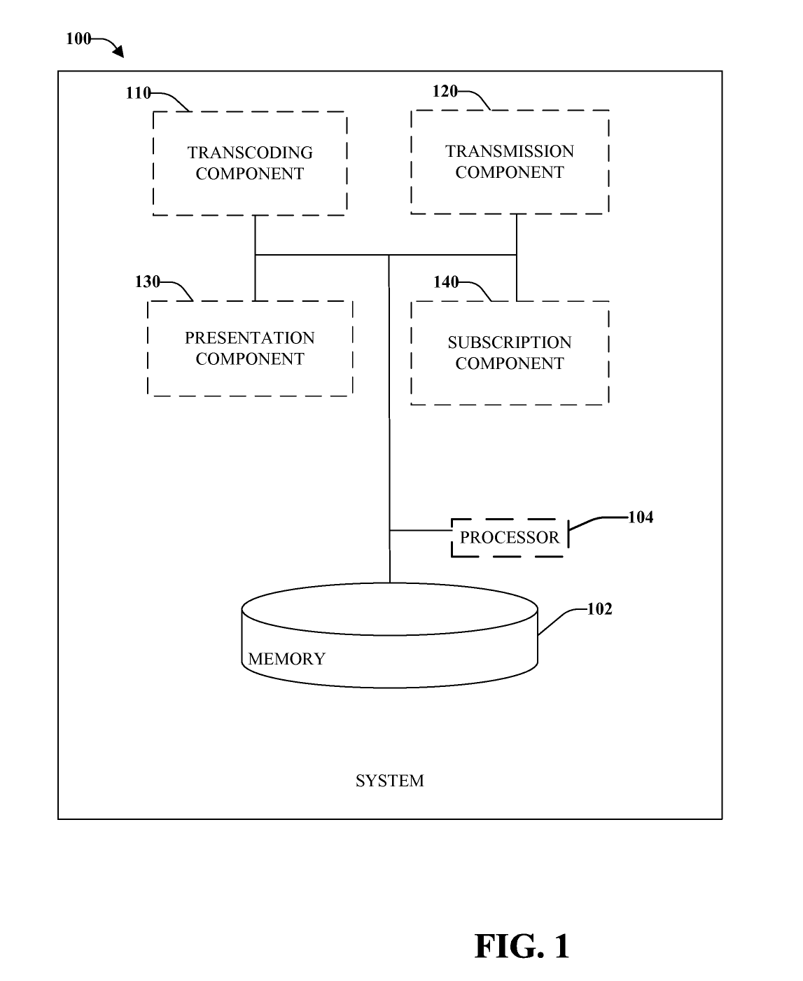

These and other embodiments or implementations are described in more detail below with reference to the drawings. Referring now to FIG. 1, illustrated is a non-limiting exemplary system 100 for creating and broadcasting a channel. In an aspect, system 100 comprises a memory 102 having stored thereon computer executable components and that stores information corresponding to a set of channels, wherein each of the set of channels comprises video content associated with at least one video; and a processor 104, coupled to the memory, configured to execute or facilitate execution of the executable components, the executable components comprising: a transcoding component 110 that converts the information corresponding to the set of channels from a system format and a system specification to converted information comprising a first format and first specification of a first device and a second format and a second specification of a second device; a transmission component 120 that transmits at least the converted information via a broadcast signal or a video data stream to an application comprising a channel store, wherein the channel store is accessible by the first device and the second device; a presentation component 130 that presents a set of channel cards and metadata via a user interface of the channel store, wherein the set of channel cards represent corresponding ones of the set of channels; and a subscription component 140 that facilitates access to a subset of the set of channels represented by a subset of the set of channel cards selected for consumption via the first device or the second device.

In an aspect, system 100 comprises transcoding component 110 that converts the information corresponding to the set of channels from a system format to a format and specification of one or more devices. The information corresponding to the channels (also referred to as smart channels) can include data, such as media data (e.g., audio data, video data, streaming content, video games, shows, etc.) and metadata. Transcoding component 110 converts information from one format to a different format of the device. A format can describe a manner to encode information so as to satisfy the criteria of a storage medium corresponding to a device. A format can correspond to a particular specification, which describes the method by which data or information is to be encoded. For instance, in an aspect, transcoding component 110 can convert media files, such as audio files and video files from one format to another formats such as mobile device formats (e.g., 3^{rd} Generation Partnership Project (3GPP), Motion Picture Experts Group (MPEG-4), Real Time Streaming Protocol (RTSP), Flash Lite, etc.), tablet formats, and other such device formats. Transcoding component 110 can also convert HTML files and graphic files to formats and specifications associated with mobile devices and web-enabled products.

In an aspect, the conversion of information to a device format or in accordance with a device specification can result in information used to in relation to features of the device such as screen size, memory capacity, and bandwidth rates. Furthermore, in an aspect, transcoding component 110 can convert information to be compatible with an application or program specific to a device. In another aspect, the conversion of information can include converting to file formats that reduce file sizes or to update data formats to newer versions that are better supported by a wider array of devices.

In another aspect, system 100 employs a transmission component 120 that transmits at least the converted information via a broadcast signal or a video data stream to an application comprising a channel store, wherein the channel store is accessible by the first device and the second device. After the transcoding component 110 converts the information to a format and specification of various devices, the converted information is distributed to the various devices via a broadcast signal (e.g., using the transmission component 120). The broadcast signal can introduce converted information to various devices in various interface standards that support numerous video resolutions (e.g., hi-definition, ultra high-definition, etc.), color depth of picture, frame rates, three-dimensional video, and picture resolutions. Transmission component 120 can also transmit data via a video data stream whereby data can be accessed and utilized while in the process of transmission. For instance, a device can play video content corresponding to a channel before the entire data file is transferred to the application accessed by the device.

In an aspect, transmission component 120 transmits a broadcast signal or a video stream to an application comprising a channel store. The channel store is a digital distribution platform that facilitates a consumer to access and view video content of a channel, a broadcaster to display video content via a channel, and an administrator to administer the channel store in accordance with a particular objective (e.g. publish content, collect revenue, etc.). In an aspect, the channel store can comprise a catalogue of channels and products wherein the channel is a product created by a broadcaster. The broadcaster can utilize the channel store to access an audience of consumers interested in purchasing the channel in order to access the channel content (e.g., shows, movies, etc.).

The channel store can comprise a channel that corresponds to a particular brand as embodied by a channel logo, name, and tagline. The broadcaster can customize the channel in a manner to suit the channel objective. For instance, a broadcaster can present a graphic identity to associate with the channel (e.g. symbol, mascot, design, etc.). The broadcaster can customize the channel to include promotional videos of upcoming releases and trailers associated with video content corresponding to the channel. In an aspect, once a channel is created and published to the channel store, a multitude of devices can then access the content corresponding to the channel. For instance, the channel can be accessed via a channel store application at a smart phone, smart television, laptop, tablet, personal computer, and other such devices.

A consumer can browse the channel store by topic, tags or type of content and ultimately subscribe to channels of interest. In an aspect, system 100 employs presentation component 130 that presents a set of channel cards and channel metadata via a user interface of the channel store, wherein the set of channel cards represent corresponding ones of the set of channels. The channel store can categorize the channels as a channel catalogue whereby the channels are represented by channel cards. The channel cards can convey information about the channel such as a channel description, content trailers, subscription pricing, and trial service information. Furthermore, the channel cards can provide information to educate a potential consumer about the channel capabilities such as popular content on channel, the devices that can access the channel, quality of the video content (including sound technology), language translations, age rating of content, and other such information. In another aspect, a consumer can browse through the channel cards to view promotional videos, popular content, channel pricing information, and trial subscription information related to the channels information. By allowing a user to browse and purchase channels a-la-carte, the consumer pays for only those channels of personal interest, which thereby enhances the customer experience. In order to facilitate easier browsing, the channel cards can be sorted by genre, topic, age rating, or other such criteria.

Upon a consumer's interest in a channel, the consumer can subscribe to a channel in accordance with a set of subscription terms. Accordingly, subscription component 140 facilitates access to a subset of the set of channels represented by a subset of the set of channel cards selected for consumption via the first device or the second device. A consumer can subscribe to any number of channels selected at the channel store and upon subscription to the selected channels, the consumer can access the content corresponding to the subset of subscribed channels. In an aspect, the subscription terms can indicate the duration of permitted access to the channels, the specific content available for consumption (e.g., live content, pre-recorded content), the quality of the content feed, subscription fees, geographical limitations and the devices permitted to access the content.

In an aspect, the consumer can subscribe to one or more channels at a regular interval to access the channels and associated video content. For instance, a consumer can purchase a monthly subscription, semi-annual subscription or annual subscription where the consumer pays at respective intervals for channel access. Furthermore, a consumer can adjust the subscription by adding channels or removing channels from a listing of subscribed channels. The subscription fee can also increase or decrease respectively based on the addition or removal of channels. Also, subscription discounts can be applied to the subscription fee based on various subscription selections by the consumer. For instance, a subscription on an annual basis can provide a subscription fee discount versus a subscription on a monthly basis due to the consumer's long-term commitment to channel access.

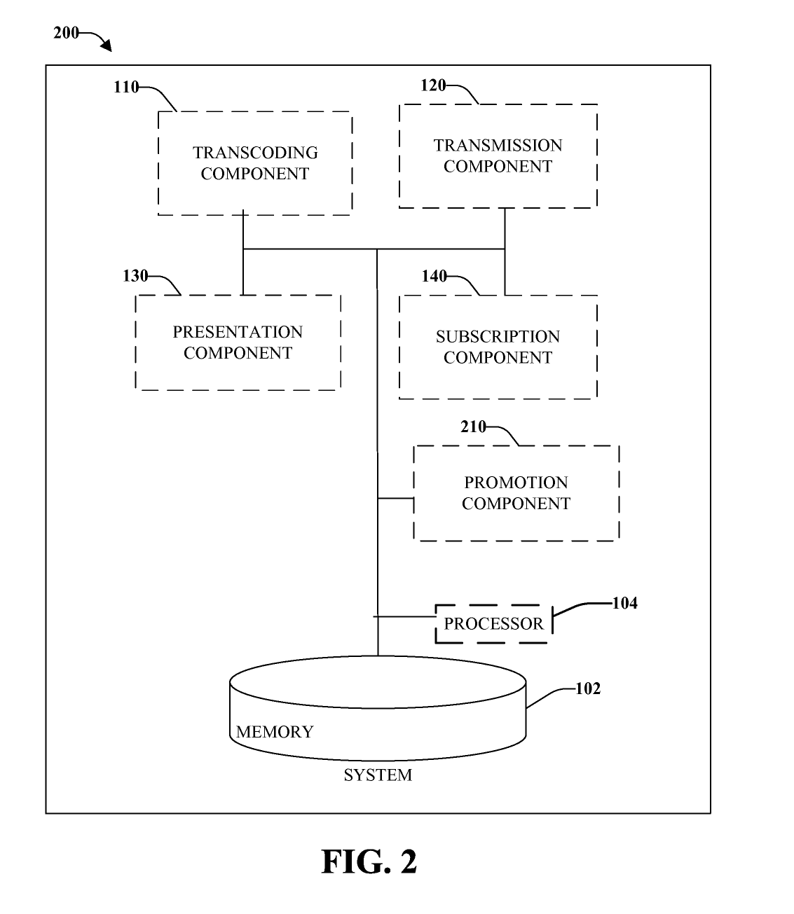

Turning now to FIG. 2, illustrated is a non-limiting exemplary embodiment of system 200 for creating and broadcasting a channel. In an aspect, system 200 employs promotion component 210 that includes an advertisement within the video content and user interface of the channel store wherein the advertisement promotes a brand or the video content. The promotion component 210 can facilitate the use of advertising in connection with presenting the channel. In an aspect, an advertisement for a product or service can be embedded within video content. For instance, an advertisement can play in a video player before, during or after a piece of video content is viewed by a consumer. In another aspect, promotion component 210 can include an advertisement within the video content whereby the advertisement can occupy the entire space of the video viewing screen or less than the entire space of the viewing screen. In an aspect, a technique can be employed whereby some of the advertisements must be viewed in order to view the non-advertisement video content of the channel. Another technique employed can allow the user to skip or close an advertisement and continue viewing the video content corresponding to the channel.

In yet another aspect, the advertisements within the video content can not only be implemented by third party advertisers of products and services, but also the channel broadcaster. The promotion component 210 can provide channel advertisements within video content that highlight popular video content or display promotional materials for upcoming shows, movies, or channel events (e.g., sporting events, concerts, etc.). The channel can also promote sister channels or sister brands owned by the channel broadcaster to raise consumer awareness of other video content and channel subscriptions available for purchase or consumption. Thus promotion component 210 facilitates advertising of a wide range of promotional content within the video content.

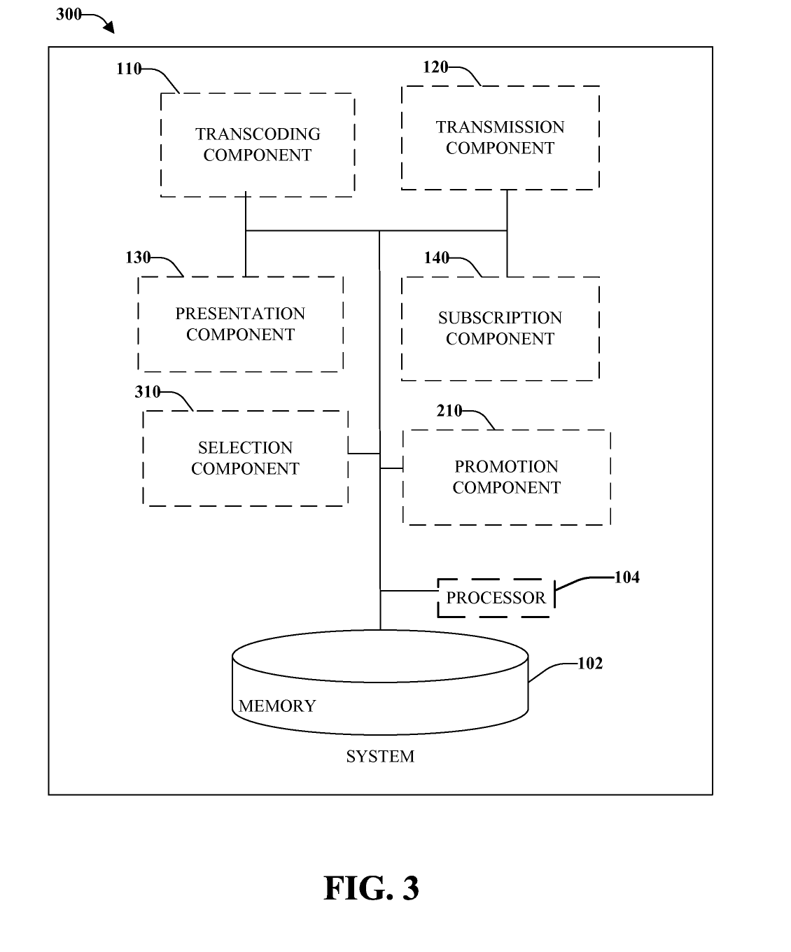

Turning now to FIG. 3, illustrated is a non-limiting exemplary embodiment of system 300 for creating and broadcasting a channel. In an aspect, system 300 employs selection component 310 that facilitates selection of the subset of channels represented by the subset of channel cards for the consumption via the first device or the second device. In an aspect, selection component 310 allows a consumer to select one or more channels from the channel store for consumption. The consumer can view the channels at a main menu screen presented at a device interface. For instance, the consumer can use a tablet or smart television to access a listing of channels represented by channel cards. The consumer can scroll left, right, up, down, and diagonally to scroll through the channels.

In another aspect, selection component 310 can facilitate the consumer selection of current content or previously released content. In an instance, selection component 310 can facilitate the consumers choosing a channel, changing a channel, or choosing a program to view within a channel. Furthermore, selection component 310 can facilitate selection of payment procedures, cancellation of payment procedures, selection of trailers for viewing, commencing a subscription procedure, entering billing information, selecting digits to enter, returning to previous screens, activating a channel, deactivating a channel, highlighting channel information, pausing playback, resuming playback, forwarding through video content, and selecting other such actions related to the channel store, channel and video content.

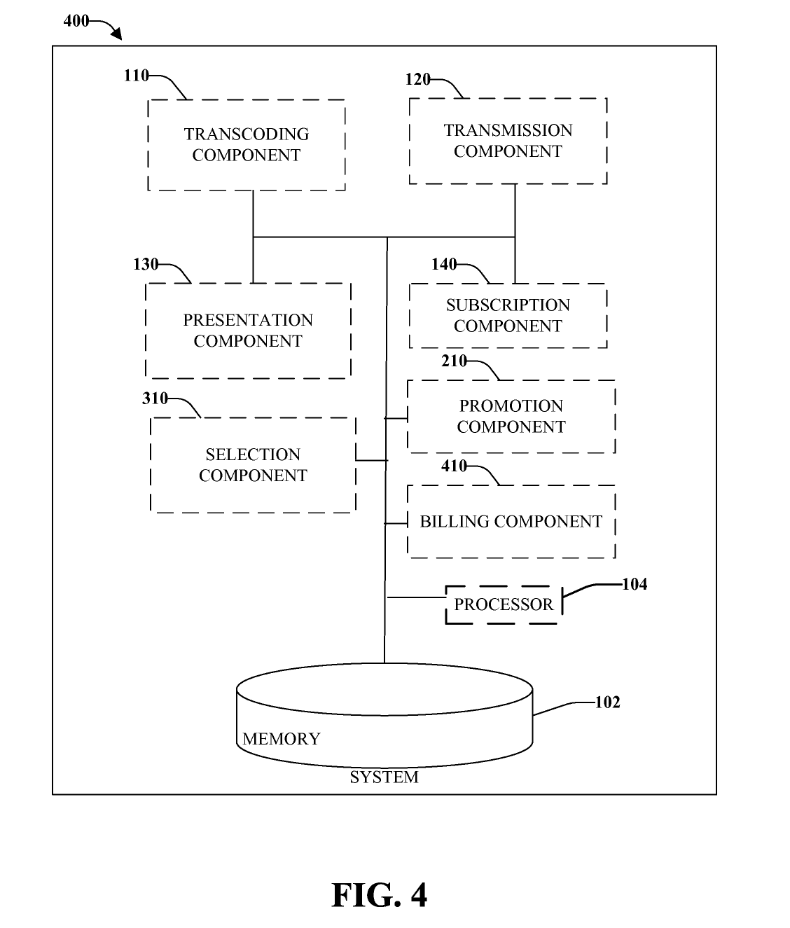

Turning now to FIG. 4, illustrated is a non-limiting exemplary embodiment of system 400 for creating and broadcasting a channel. In an aspect, system 400 employs billing component 410 that determines a customized fee associated with the subset of channels selected for the consumption via the first device or the second device. As a consumer subscribes (e.g., using subscription component 140) to various channels the consumer will incur a subscription fee. In an aspect, billing component determines a customized fee based on the channels selected and the fee can be based on various models. In an instance, each channel can cost a flat fee per channel. The flat fee per channel can include a range of flat fees based on the length of the subscription timeframe such that the longer the subscription commitment, the lower the fee incurred by the consumer. In another aspect, billing component 410 can determine a customized fee based on aggregate channel discounts. For instance, the customized fee can be lessened as a consumer purchases more channel subscriptions. Thus bulk channel purchases can reward customers with lower fees.

Furthermore, billing component 410 can determine a discounted customized fee for a subscription to a bundle of channels. In an aspect, such discounts can help facilitate subscription revenue for weaker selling channels by including them in a discounted bulk purchase of channels. Billing component 410 can incorporate such discounts based on broadcaster specified or administrator specified directives. In another aspect, billing component 410 can determine a customized fee based on premium fee models. For instance, a premium fee model can associate premium payments with niche-oriented content based on specific audience interests such as live musical performances, premium show content, and exclusive sporting events. In another aspect, billing component 410 can determine the customized fee based on a la carte services optionally provided to the consumer such as providing a second screen of information to accompany a particular event or event simulcasting on a device. Furthermore, the customized fee can be adjusted based on special offerings such as holiday discounts, free limited time content access, coupon promotions, or mobile device quick codes.

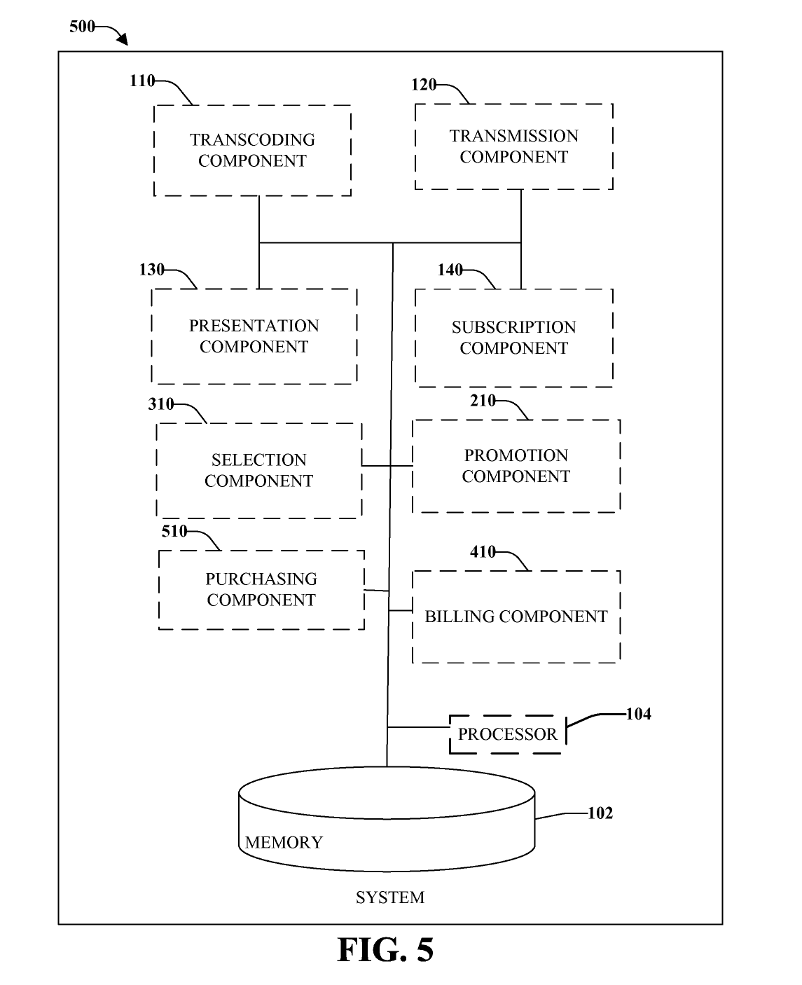

Turning now to FIG. 5, illustrated is a non-limiting exemplary embodiment of system 500 for creating and broadcasting a channel. In an aspect, system 500 employs purchasing component 510 that receives a payment from a payment source based on the customized fee. Once a consumer subscribes (e.g. using subscription component 140) to a channel and determines (e.g., using billing component 410) a customized fee, the consumer can proceed with a payment procedure. In an aspect, the consumer can input billing information such as payment details (e.g., credit card details, address, etc.). The payment component 510 receives a payment provided by the consumer from a payment source (e.g., checking account, online payment account, credit card intermediary, etc.) based on the specified customized fee. In an aspect, the consumer can link a payment instrument, such as a credit card, to the consumer account. The payment component 510 can receive a payment on a periodic basis based upon the consumer's preferences.

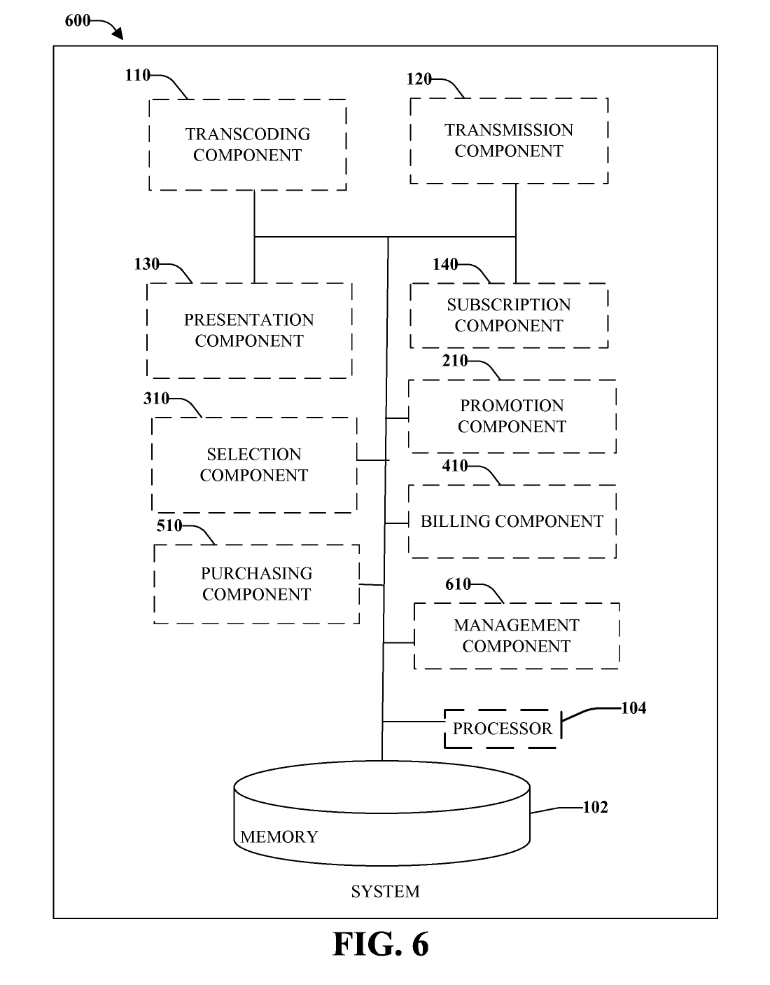

Turning now to FIG. 6, illustrated is a non-limiting exemplary embodiment of system 600 for creating and broadcasting a channel. In an aspect, system 600 employs management component 610 that permits or restricts the presentation of the video content at least in part via the first device or via the second device based on a user designated preference or an administrator designated preference. In an instance, the video content corresponding to a channel can be presented on one or more specified devices. A consumer can utilize management component 610 to access channels on more than one device. For instance, a consumer can access a subscribed channel at a mobile phone, tablet computer, smart television, and computer. Accordingly, the customized fee can be determined (e.g. using billing component 410) based on the number of devices to access the video content. In another aspect, an administrator, such as the channel broadcaster, can set the devices to broadcast the video content.

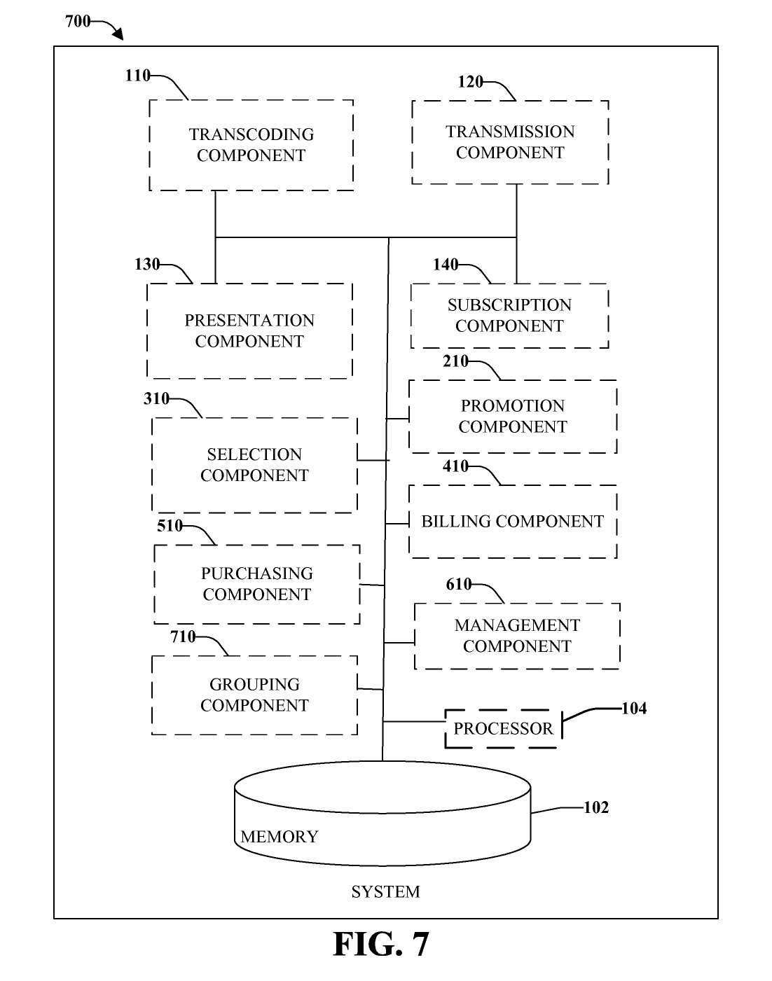

Turning now to FIG. 7, illustrated is a non-limiting exemplary embodiment of system 700 for creating and broadcasting a channel. In an aspect, system 700 employs grouping component 710 that groups a first subset of the set of channel cards representing a first subset of the set of channels at the channel store based on a tag, a topic, a genre, a category, metadata or a keyword or an event, and wherein offer data is generated representing an offer for sale for the first subset of channels as a function of the customized fee. In an aspect, the grouping component 710 can group a bundle of channels based on various commonalities such as a tag, topic, genre, category, metadata, keyword, or an event. Furthermore, grouping component 710 in connection with billing component 510 can determine a customized fee for the grouped set of channels.

By grouping together similar channels, consumers can identify new channels for subscription based on the factors of interest to the consumer. Furthermore, the grouped channels can be offered at a discounted customized fee to attract a targeted audience for subscription of the channels. In an aspect, grouping component 710 in connection with promotion component 210 can include advertisements within similar video content that is grouped together. For instance, channels that are grouped together by similarity of a genre such as presentation of dramatic video content can promote similar advertisements or similar trailers. The audience for the grouped channels may have similar interests and thus may have similar interests corresponding to targeted advertisement or promotional content.

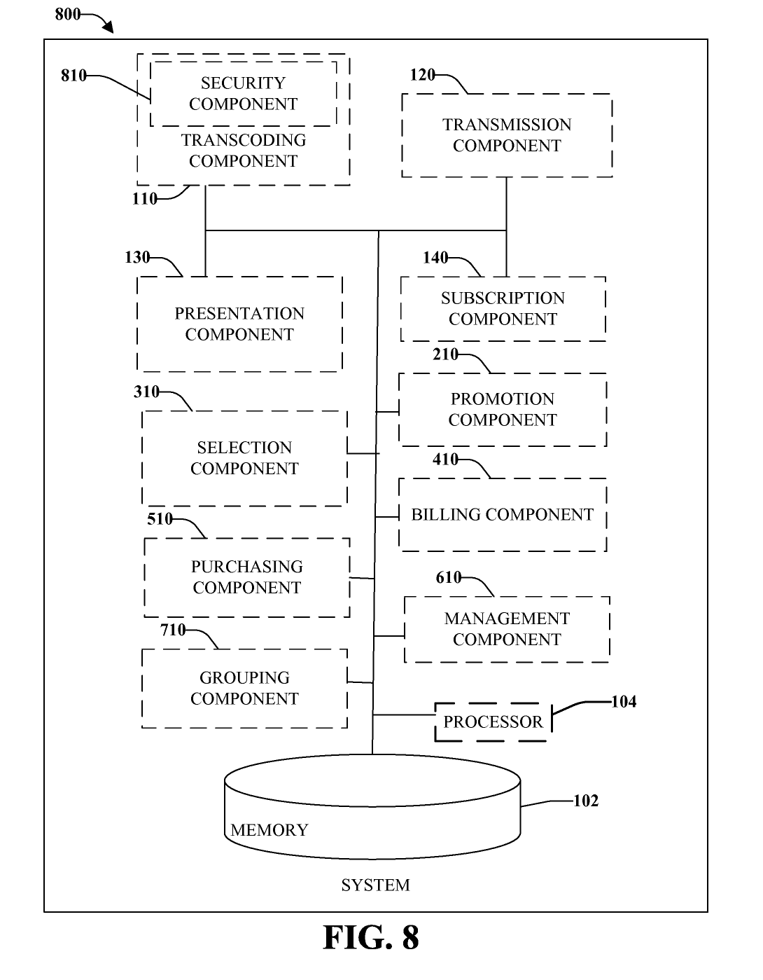

Turning now to FIG. 8, illustrated is a non-limiting exemplary embodiment of system 800 for creating and broadcasting a channel. In an aspect, system 800 comprises transcoding component 110 that employs a security component 810 that encrypts the converted information for transmission. In an aspect, security component 810 can scramble the converted information, such as text, image, audio, and video data to make the data unreadable during transmission. Thus security component 810 can protect the data during transmission from unauthorized users accessing such data. In an aspect, security component 810 can encrypt the video data by utilizing an algorithm such as a naïve algorithm (e.g., encrypts each byte of an MPEF stream using standard encryption techniques) or a pure permutation algorithm (e.g., scrambles bytes within a frame of an MPEG stream by permutation). Furthermore, in another aspect, given the large size of digital video data files, the files can often be compressed prior to transmission, thus any encryption algorithms employed by security component 810 can operate with compressed data and non-compressed data.

Turning now to FIG'S. 9-14 illustrated are methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be further appreciated that the methods disclosed hereinafter and throughout this specification are capable of being stored on an article of manufacture to facilitate transporting and transferring such methods to computers. The term article of manufacture, as used herein, is intended to encompass a computer program accessible from any computer-readable device, carrier, or media.

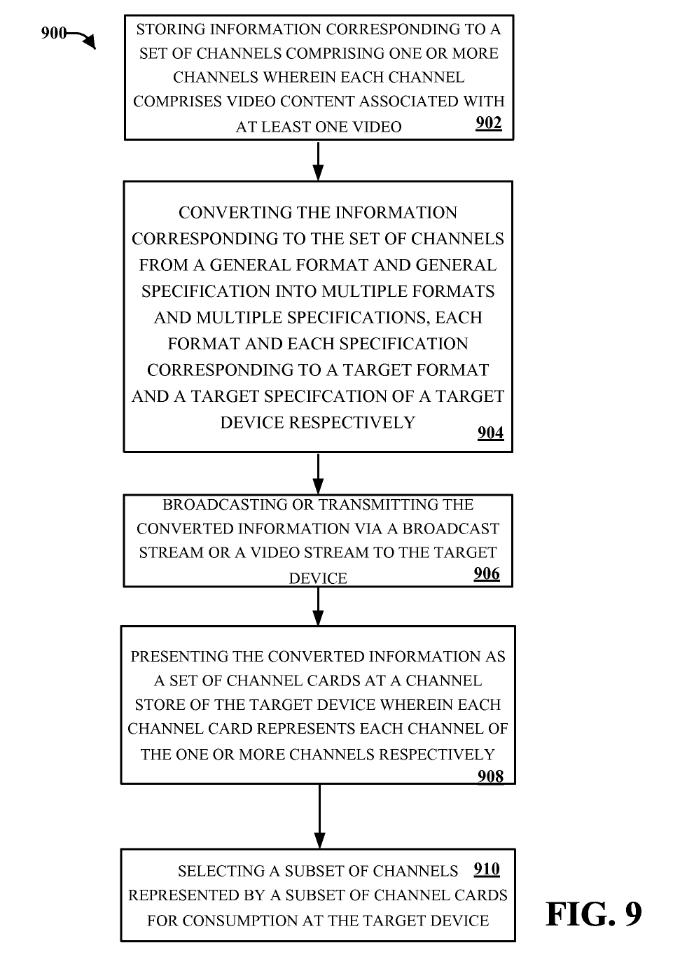

Referring to FIG. 9, an example method 900 that can present one or more channels at a channel store accessible by one or more devices in accordance with various embodiments and aspects of the disclosed subject matter is illustrated. At 902, a device comprising a processor can be configured to store information (by using memory 102) corresponding to a set of channels comprising one or more channels wherein each channel comprises video content associated with at least one video. At 904, the device can be configured to convert (e.g., using transcoding component 110) the information corresponding to the one or more channels from a standard format and a standard specification into multiple formats and multiple specifications corresponding to respective target formats and respective target specifications of respective target devices.

At 906, the device can be configured to broadcast or transmit (e.g., using transmission component 120) the converted information as a video stream to the target device. At 908, the device can be configured to instruct the converted information to be presented (e.g., using presentation component 130) as a set of channel cards via an interface of a channel store of a target device of the respective target devices, wherein the set of channel cards respectively represents the one or more channels. At 910, the device can be configured to select (e.g., using selection component 310) a subset of the set of channels represented by a corresponding subset of the set of channel cards for consumption by the target device.

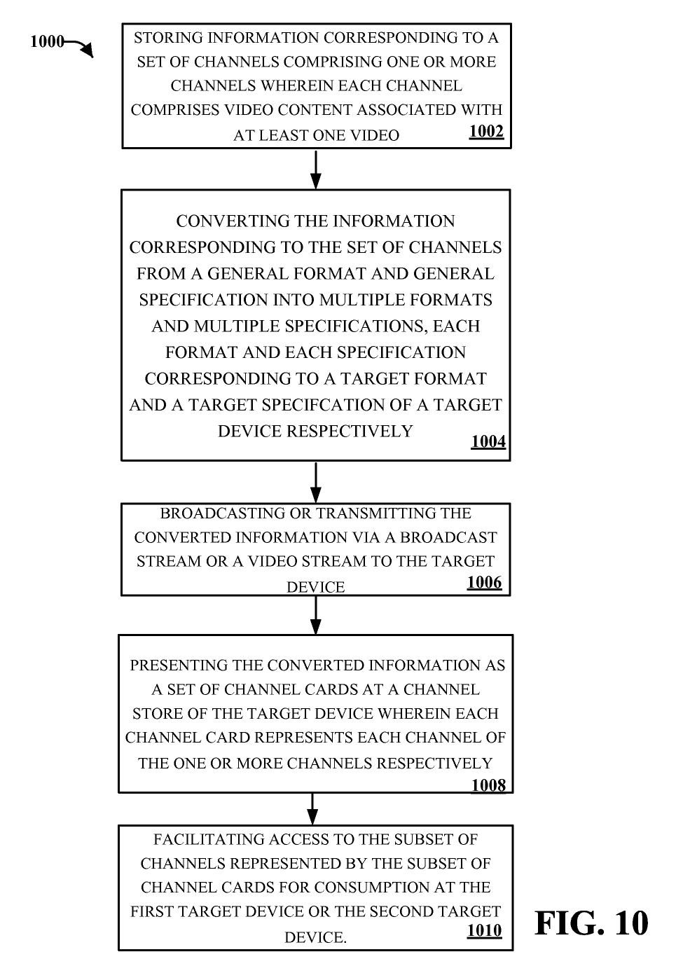

Referring to FIG. 10, an example method 1000 that can present one or more channels at a channel store accessible by one or more devices in accordance with various embodiments and aspects of the disclosed subject matter is illustrated. At 1002, a device comprising a processor can be configured to store information (by using memory 102) corresponding to a set of channels comprising one or more channels wherein each channel comprises video content associated with at least one video. At 1004, the device can be configured to convert (e.g., using transcoding component 110) the information corresponding to the one or more channels from a standard format and a standard specification into multiple formats and multiple specifications corresponding to respective target formats and respective target specifications of respective target devices.

At 1006, the device can be configured to broadcast or transmit (e.g., using transmission component 120) the converted information as a video stream to the target device. At 1008, the device can be configured to instruct the converted information to be presented (e.g., using presentation component 130) as a set of channel cards via an interface of a channel store of a target device of the respective target devices, wherein the set of channel cards respectively represents the one or more channels. At 1010, the device can be configured to facilitate access to the subset of channels represented by the subset of channel cards for consumption at the first target device or the second target device.

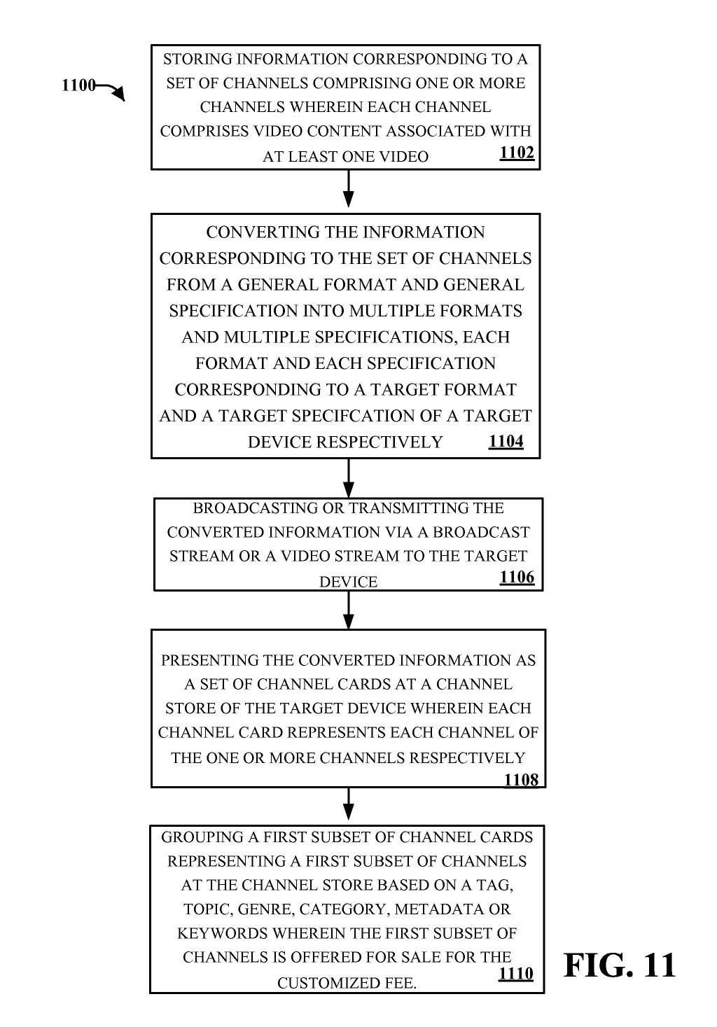

Referring to FIG. 11, an example method 1100 that can present one or more channels at a channel store accessible by one or more devices in accordance with various embodiments and aspects of the disclosed subject matter is illustrated. At 1102, a device comprising a processor can be configured to store information (by using memory 102) corresponding to a set of channels comprising one or more channels wherein each channel comprises video content associated with at least one video. At 1104, the device can be configured to convert (e.g., using transcoding component 110) the information corresponding to the one or more channels from a standard format and a standard specification into multiple formats and multiple specifications corresponding to respective target formats and respective target specifications of respective target devices.

At 1106, the device can be configured to broadcast or transmit (e.g., using transmission component 120) the converted information as a video stream to the target device. At 1108, the device can be configured to instruct the converted information to be presented (e.g., using presentation component 130) as a set of channel cards via an interface of a channel store of a target device of the respective target devices, wherein the set of channel cards respectively represents the one or more channels. At 1110, the device can be configured to group (e.g., using grouping component 710) a first subset of channels at the channel store based on a tag, topic, genre, category, metadata or keywords wherein the first subset of channels is offered for sale for the customized fee.

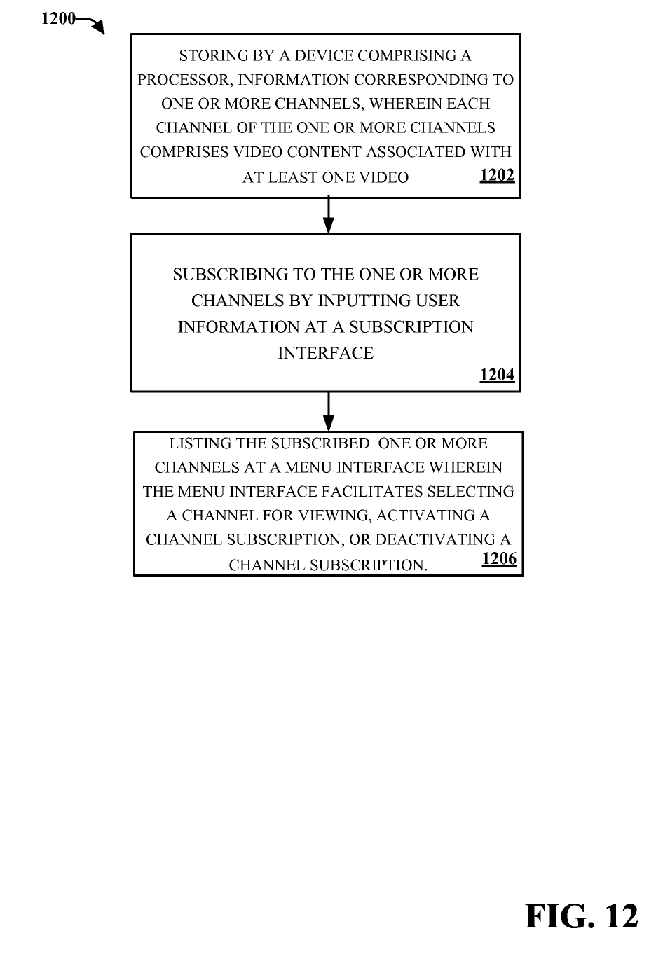

Referring to FIG. 12, an example method 1200 that can present one or more channels at a channel store accessible by one or more devices in accordance with various embodiments and aspects of the disclosed subject matter is illustrated. At 1202, a device comprising a processor can be configured to store information corresponding to one or more channels, wherein each channel of the one or more channels comprises video content associated with at least one video. At 1204, the device can be configured to subscribe to the one or more channels by inputting user information at a subscription interface. At 1206, the device can be configured to list the subscribed one or more channels at a menu interface wherein the menu interface facilitates selecting a channel for viewing, activating a channel subscription, or deactivating a channel subscription.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

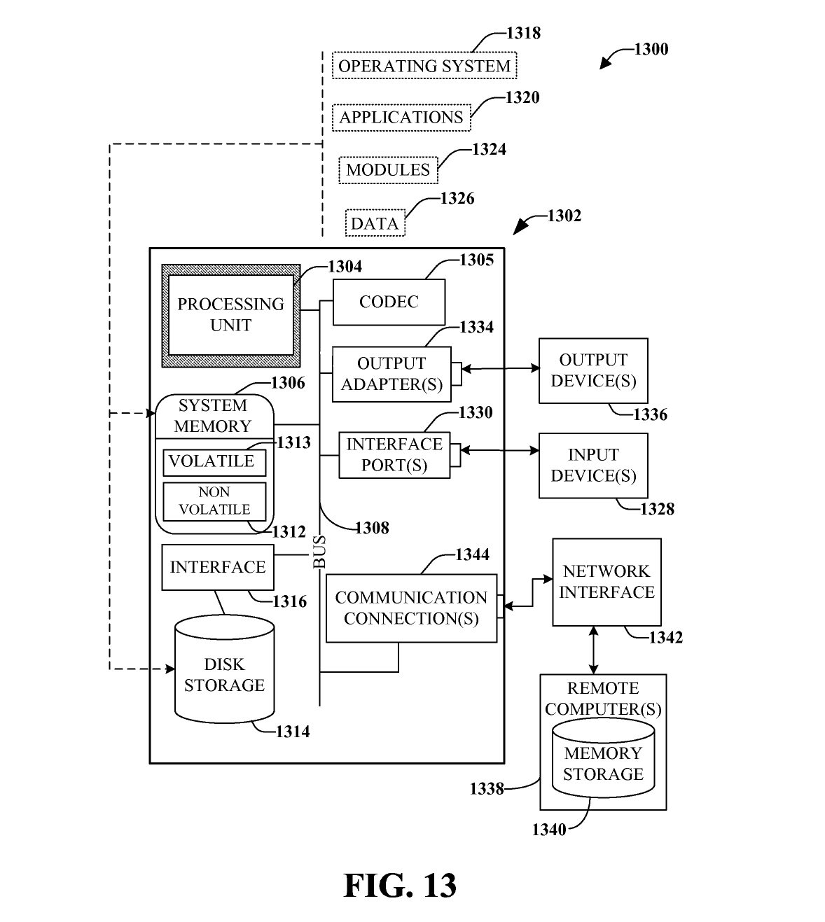

With reference to FIG. 13, a suitable environment 1300 for implementing various aspects of the claimed subject matter includes a computer 1302. The computer 1302 includes a processing unit 1304, a system memory 1306, a codec 1305, and a system bus 1308. The system bus 1308 couples system components including, but not limited to, the system memory 1306 to the processing unit 1304. The processing unit 1304 can be any of various available processors. Dual microprocessors and other multiprocessor architectures also can be employed as the processing unit 1304.

The system bus 1308 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1306 includes volatile memory 1310 and non-volatile memory 1312. The basic input/output system (BIOS), containing the basic routines to transfer information between elements within the computer 1302, such as during start-up, is stored in non-volatile memory 1312. In addition, according to various embodiments, codec 1305 may include at least one of an encoder or decoder, wherein the at least one of an encoder or decoder may consist of hardware, a combination of hardware and software, or software. Although, codec 1305 is depicted as a separate component, codec 1305 may be contained within non-volatile memory 1312. By way of illustration, and not limitation, non-volatile memory 1312 can include read only memory (ROM), programmable ROM (PROM), electrically programmable ROM (EPROM), electrically erasable programmable ROM (EEPROM), or flash memory. Volatile memory 1310 includes random access memory (RAM), which acts as external cache memory. According to present aspects, the volatile memory may store the write operation retry logic (not shown in FIG. 13) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1302 may also include removable/non-removable, volatile/non-volatile computer storage medium. FIG. 13 illustrates, for example, disk storage 1314. Disk storage 1314 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1314 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1314 to the system bus 1308, a removable or non-removable interface is typically used, such as interface 1316.

It is to be appreciated that FIG. 13 describes software that acts as an intermediary between users and the basic computer resources described in the suitable operating environment 1300. Such software includes an operating system 1318. Operating system 1318, which can be stored on disk storage 1314, acts to control and allocate resources of the computer system 1302. Applications 1320 take advantage of the management of resources by the operating system through program modules 1324, and program data 1326, such as the boot/shutdown transaction table and the like, stored either in system memory 1306 or on disk storage 1314. It is to be appreciated that the claimed subject matter can be implemented with various operating systems or combinations of operating systems.

A user enters commands or information into the computer 1302 through input device(s) 1328. Input devices 1328 include, but are not limited to, a pointing device such as a mouse, trackball, stylus, touch pad, remote control unit, keyboard, microphone, joystick, game pad, satellite dish, scanner, TV tuner card, digital camera, digital video camera, web camera, and the like. These and other input devices connect to the processing unit 1304 through the system bus 1308 via interface port(s) 1330. Interface port(s) 1330 include, for example, a serial port, a parallel port, a game port, and a universal serial bus (USB). Output device(s) 1336 use some of the same type of ports as input device(s) 1328. Thus, for example, a USB port may be used to provide input to computer 1302, and to output information from computer 1302 to an output device 1336. Output adapter 1334 is provided to illustrate that there are some output devices 1336 like monitors, speakers, and printers, among other output devices 1336, which require special adapters. The output adapters 1334 include, by way of illustration and not limitation, video and sound cards that provide a means of connection between the output device 1336 and the system bus 1308. It should be noted that other devices and/or systems of devices provide both input and output capabilities such as remote computer(s) 1338.

Computer 1302 can operate in a networked environment using logical connections to one or more remote computers, such as remote computer(s) 1338. The remote computer(s) 1338 can be a personal computer, a server, a router, a network PC, a workstation, a microprocessor based appliance, a peer device, a smart phone, a tablet, or other network node, and typically includes many of the elements described relative to computer 1302. For purposes of brevity, only a memory storage device 1340 is illustrated with remote computer(s) 1338. Remote computer(s) 1338 is logically connected to computer 1302 through a network interface 1342 and then connected via communication connection(s) 1344. Network interface 1342 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, Digital Subscriber Lines (DSL), digital video broadcasting (DVB) such as DVB-T/C/S, satellite (SAT) TV, IP, and over the top (OTT) content.

Communication connection(s) 1344 refers to the hardware/software employed to connect the network interface 1342 to the bus 1308. While communication connection 1344 is shown for illustrative clarity inside computer 1302, it can also be external to computer 1302. The hardware/software necessary for connection to the network interface 1342 includes, for exemplary purposes only, internal and external technologies such as, modems including regular telephone grade modems, cable modems and DSL modems, ISDN adapters, and wired and wireless Ethernet cards, hubs, and routers.

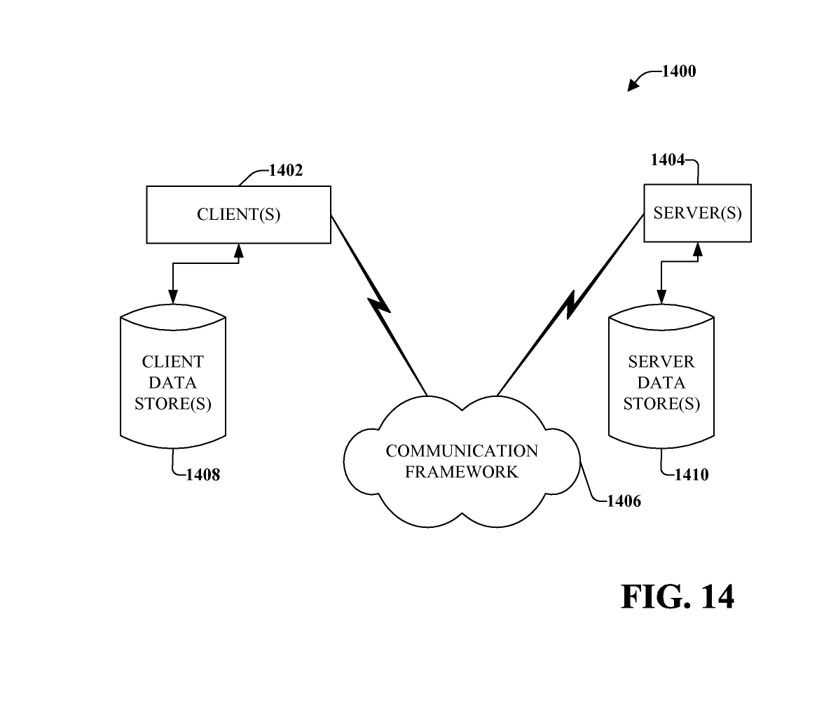

Referring now to FIG. 14, there is illustrated a schematic block diagram of a computing environment 1400 in accordance with this disclosure. The system 1400 includes one or more client(s) 1402 (e.g., laptops, smart phones, PDAs, media players, computers, portable electronic devices, tablets, and the like). The client(s) 1402 can be hardware and/or software (e.g., threads, processes, computing devices). The system 1400 also includes one or more server(s) 1404. The server(s) 1404 can also be hardware or hardware in combination with software (e.g., threads, processes, computing devices). The servers 1404 can house threads to perform transformations by employing aspects of this disclosure, for example. One possible communication between a client 1402 and a server 1404 can be in the form of a data packet transmitted between two or more computer processes wherein the data packet may include video data. The data packet can include a metadata, such as associated contextual information for example. The system 1400 includes a communication framework 1406 (e.g., a global communication network such as the Internet, or mobile network(s)) that can be employed to facilitate communications between the client(s) 1402 and the server(s) 1404.

Communications can be facilitated via a wired (including optical fiber) and/or wireless technology. The client(s) 1402 include or are operatively connected to one or more client data store(s) 1408 that can be employed to store information local to the client(s) 1402 (e.g., associated contextual information). Similarly, the server(s) 1404 are operatively include or are operatively connected to one or more server data store(s) 1410 that can be employed to store information local to the servers 1404.

In one embodiment, a client 1402 can transfer an encoded file, in accordance with the disclosed subject matter, to server 1404. Server 1404 can store the file, decode the file, or transmit the file to another client 1402. It is to be appreciated, that a client 1402 can also transfer uncompressed file to a server 1404 and server 1404 can compress the file in accordance with the disclosed subject matter. Likewise, server 1404 can encode video information and transmit the information via communication framework 1406 to one or more clients 1402.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the various embodiments. Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the various embodiments are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the various embodiments include a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the various embodiments may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a memory having stored thereon executable components and that stores information corresponding to a set of channels, wherein each of the set of channels comprises video content associated with at least one video; and
a processor, coupled to the memory, configured to execute or facilitate execution of the executable components, the executable components comprising:
a transcoding component that converts the information corresponding to the set of channels from a system format and a system specification to converted information comprising a first format and a first specification of a first device and a second format and a second specification of a second device;
a transmission component that transmits at least the converted information via a broadcast signal or a video data stream to an application comprising a channel store, wherein the channel store is accessible by the first device and the second device;
a presentation component that presents a set of channel cards and channel metadata via a user interface of the channel store, wherein the set of channel cards represent corresponding ones of the set of channels; and
a subscription component that facilitates access to a subset of the set of channels represented by a subset of the set of channel cards selected for consumption via the first device or the second device.

2. The system of claim 1, wherein the executable components further comprise a promotion component that includes an advertisement within the video content and the user interface of the channel store, wherein the advertisement promotes a brand or the video content.

3. The system of claim 1, wherein the executable components further comprise a selection component that facilitates selection of the subset of channels represented by the subset of channel cards for the consumption via the first device or the second device.

4. The system of claim 1, wherein the executable components further comprise a billing component that determines a customized fee associated with the subset of channels selected for the consumption via the first device or the second device.

5. The system of claim 4, wherein the executable components further comprise a purchasing component that receives a payment from a payment source based on the customized fee.

6. The system of claim 1, wherein the executable components further comprise a management component that permits or restricts the presentation of the video content at least in part via the first device or via the second device based on a user designated preference or an administrator designated preference.

7. The system of claim 1, wherein each channel card of the set of channel cards comprises channel information and metadata corresponding to respective channels of the set of channels, and wherein, for each channel, the channel information and metadata comprises a channel logo, a channel title, a branding element, a channel description, popular video content for the channel, a channel trailer, a video content trailers, an age rating of the video content or the whole channel, a channel genres, a channel prices, purchasing options, video content streaming options, or subscription information relating to a subscription to the channel.

8. The system of claim 4, wherein the executable components further comprise a grouping component that groups a first subset of the set of channel cards representing a first subset of the set of channels at the channel store based on a tag, a topic, a genre, a category, metadata or a keyword or an event, and wherein offer data is generated representing an offer for sale for the first subset of channels as a function of the customized fee.

9. The system of claim 8, wherein the customized fee is based on a defined price per channel of the first subset of channels or a customized price for the first subset of channels.

10. The system of claim 1, wherein transcoding component employs a security component that encrypts the converted information for transmission.

11. A method, comprising:
storing, by a device comprising a processor, information corresponding to one or more channels, wherein each channel of the one or more channels comprises video content associated with at least one video;
converting the information to converted information corresponding to the one or more channels from a standard format and a standard specification into multiple formats and multiple specifications corresponding to respective target formats and respective target specifications of respective target devices;
broadcasting or transmitting the converted information as a video stream to the target device;
instructing the converted information to be presented as a set of channel cards via an interface of a channel store of a target device of the respective target devices, wherein the set of channel cards respectively represents the one or more channels; and
selecting a subset of the set of channels represented by a corresponding subset of the set of channel cards for consumption by the target device.

12. The method of claim 11, further comprising facilitating access to the subset of channels represented by the corresponding subset of channel cards for consumption by the target device.

13. The method of claim 12, further comprising receiving a payment from a payment source based on a fee for consumption of the subset of channels, wherein the payment is based on a number of target devices accessing the subset of channels.

14. The method of claim 12, further comprising receiving a payment from a payment source based on a fee for consumption of the subset of channels, wherein the payment is based on a per channel price of the subset of channels.

15. The method of claim 12, further comprising receiving a payment from a payment source based on a fee for consumption of the subset of channels, wherein the payment is based on a bulk price for the subset of channels.

16. The method of claim 13, further comprising grouping a first subset of the set of channel cards representing a first subset of channels based on a tag, a topic, a genre, a category, metadata or a keyword or an event, wherein a price to offer the first subset of channels is determined as a function of the fee for consumption.

17. The method of claim 11, further comprising permitting or restricting the presentation of video content at least in part at the target device based on a user preference or an administrator preference.

18. The method of claim 11, wherein the set of channel cards presented via the interface of the channel store for the target device and the set of channels represented by a corresponding subset of the set of channel cards are accessible for display via a unified interface of each target device of the respective target devices.

19. A computer readable storage device comprising executable instructions that, in response to execution, cause a system comprising a processor to perform operations, comprising:
including a channel card with a set of channel cards displayable via a channel store, wherein the channel card represents a channel of a set of channels represented by the set of channel cards, and wherein the set of channels and the channel comprise video content;
grouping the set of channel cards respectively representing the set of channels for display via the channel store;
receiving a selection of the set of channel cards representing the set of channels and the channel card representing the channel for consumption of the video content corresponding to the set of channels and the channel; and
transmitting the set of channels and the channel to a set of target devices based on a user preference.

20. The computer readable storage device of claim 17, wherein the operations further comprise initiating display of promotion data to promote the channel via the channel store based on a snippet of the video content or using metadata associated with the channel.

21. A method, comprising:
storing, by a device comprising a processor, information corresponding to one or more channels, wherein each channel of the one or more channels comprises video content associated with at least one video;
subscribing to the one or more channels by inputting user information at a subscription interface; and
listing the subscribed one or more channels at a menu interface wherein the menu interface facilitates selecting a channel for viewing, activating a channel subscription, deactivating a channel subscription, displaying metadata corresponding to a channel, displaying metadata corresponding to live video content, or displaying metadata corresponding to previously broadcasted video content.

22. The method of claim 21, wherein the subscribing further comprises paying a subscription fee at a regular interval to access the video content corresponding to the subscribed one or more channels.

23. The method of claim 21, wherein the deactivating a channel subscription comprises revoking access to one or more channels of the subscribed one or more channels and removing the one or more channels from the listing of the subscribed one or more channels.

24. The method of claim 21, wherein the activating a channel subscription comprises permitting access to an additional channel and adding the additional channel on the listing of the subscribed one or more channels.
